(19) United States
(12) Patent Application Publication
(10) Pub. No.: US 2012/0164266 A1
(43) Pub. Date: Jun. 28, 2012

(54) PROCESS FOR THE TOTAL OR PARTIAL REPLACEMENT OF TALC IN CHEWING GUM

(75) Inventors: Baptiste Boit, Bethune (FR); Philippe Lefevre, Haverskerque (FR); Jose Lis, La Gorgue (FR); Dominique Ortiz De Zarate, Merville (FR)

(73) Assignee: ROQUETTE FRERES, Lestrem (FR)

(21) Appl. No.: 13/393,590

(22) PCT Filed: Aug. 6, 2010
(86) PCT No.: PCT/FR10/51676

§ 371 Date: Mar. 1, 2012

(30) Foreign Application Priority Data
Sep. 1, 2009 (FR) 09 55960

(51) Int. Cl. A23G 4/06

(52) U.S. Cl. 426/5

(57) ABSTRACT

Disclosed is a method of production of chewing gum including a step of mixing the ingredients, a step of extrusion of the mixture, a step of dusting with a dusting powder, a rolling step and a forming-cutting step, wherein the dusting powder includes a pulverulent composition containing from 28% to 0.1%, preferably from 25% to 1% of particles of diameter below 75 μm and of hygroscopicity between 0.01 and 5%, the pulverulent composition including at least one polyol. Also disclosed is the chewing gum obtained by application of the method.

The present invention relates to a method for producing a chewing gum and more particularly to the partial or complete replacement of talc in such a method.

Processes for producing chewing gums generally comprise five steps (Formulation and production of chewing and bubble gum, edited by Douglas Fritz, Kennedy's Publications Ltd, London, UK). During the first step, the various compounds are mixed using a kneading machine comprising 2 Z-shaped blades. The complete cycle of the operation lasts from 15 to 20 minutes and the ingredients are added as the kneading proceeds in the kneading machine. In order to render the gum base malleable, the latter is heated beforehand and during mixing. At the end of kneading, the temperature of the paste is approximately 50° C. Two main groups are distinguished among the constituent ingredients of chewing gums, which groups are the elements which are insoluble in water and thus in the saliva, such as mainly the base gum, and the components which are soluble in water, conferring on the chewing gum its flavor, such as sweeteners in particular. The mixing step is followed by a second step of extrusion under hot conditions in order to obtain a strip of chewing gum which is narrower or wider according to the device used. In order to reduce the thickness of the strip obtained, a rolling step is provided. During this step, the strip passes successively between several pairs of rollers of decreasing separation. The rolling step is followed by a final step of forming/cutting, which can be a simple step of forming combined with a cutting or preliminary cutting of the strip obtained before packaging. In point of fact, after the step of extrusion under hot conditions, the strip of gum is extremely sticky. In fact, in order to prevent it from being destroyed or losing its integrity during rolling, a step of dusting on both faces of the strip is conventionally carried out between the steps of extrusion and of rolling. Numerous agents are used in the dusting powders. Thus, plasticizing agents or anticaking agents, such as talc, calcium carbonate, tricalcium phosphate, silica or silicates, are encountered. All these inorganic agents are capable of damaging the organoleptic properties of the chewing gums obtained. This is because these agents are insoluble and are without flavor, indeed even unpleasant, in the mouth.

Furthermore, the most widely used powder for dusting is talc. In point of fact, talc may be contaminated by a product having a very similar yet nevertheless very toxic chemical nature: asbestos. Thus, contaminated talc might be involved in processes of cancerization, whether of the digestive tract, following absorption by the oral route, or of pulmonary tissue, during absorption by the respiratory route, in particular during the handling thereof. The handling of talc is thus regulated and respiratory protective equipment is obligatory for production personnel.

In order to reduce the amounts of talc incorporated during the preparation of chewing gums and while preventing the dusting powder from being felt on the tongue during the tasting of the chewing gum, use has been made for a long time of icing sugar with a particle size close to that of talc (powder with a particle size of less than 40 μm and with a mean diameter of less than 10 μm). This use was always carried out as a mixture as icing sugar has very poor flow. Icing sugar was then replaced with powders formed of non-hygroscopic polyols, such as in particular mannitol. In the same way as for icing sugar, the powders formed of polyols used have very fine particle sizes. The most widely used powders have an amount of particles of less than 75 μm of the order of 95 to 75% for a mean particle size of 65 to 20 μm. Thus, the richness in particles having fine particle sizes was for a long time regarded as very favorable in this application, whether with regard to the gritty nature or the replacement of the talc.

However, complete replacement of the talc by these powders is not recommended since they have very poor flow, rendering them unsuitable for dusting. In the case of partial replacement, the talc, which has good flow, confers a flow on the mixture which is still mediocre but sufficient to allow the dusting of the strip of chewing gum. In point of fact, even in the context of partial replacement of the talc, the reduction in flow of the powder mixture is such that it constricts the deposition of a large amount of powder on the strip of chewing gum, resulting in fact in significant waste, in a deterioration in the quality of the chewing gums obtained, or in a modification to the conditions for regulating the devices.

Furthermore, the small particle size of these powders increases the generation of dust in suspension in the air, thus accentuating the risks for the handlers associated with the presence of asbestos in the talc.

In addition, the dusting powders do not always make it possible to obtain a uniform dusting layer. Thus, the creation is observed of nondusted or insufficiently dusted regions constituting regions of sticking of the strip of chewing gum to the rolling instruments, which are responsible for the deterioration in the strips and in fact the interruption of the manufacturing process.

Finally, a phenomenon of solidification, in their packaging, of the powders formed of polyols having fine particle sizes is observed. This is because these powders are unstable in that they cake on storage or during transportation. The bodies obtained can only be broken up by exerting very high forces. This phenomenon presents a problem in the context of the production of chewing gum in that it may be responsible for the formation of compact aggregates capable of blocking the equipment for dusting the chewing gums.

Although the use of anticaking agents in the food industry results in regulatory constraints since they may be regarded as toxic or dangerous, this solution has been envisaged. However, while a reduction in the caking has been demonstrated in the case of powders formed of hygroscopic polyols, no similar change in behavior was observed for powders formed of polyols having little or no hygroscopicity.

In order to have an efficient process, which is easy to implement, without danger to the handlers, which makes it possible to obtain a chewing gum comprising no or little in the way of inorganic agents, such as talc, while maintaining, indeed even improving, the organoleptic qualities of the chewing gums obtained, the invention relates to a method for producing chewing gums comprising a step of mixing the ingredients, a step of extruding the mixture, a step of dusting with a dusting powder, a step of rolling and a step of forming/cutting, in which the dusting powder comprises a pulverulent composition comprising less than 28%, preferably from 28% to 0.1%, typically from 25% to 1%, more preferably from 20 to 2%, and even more preferably from 15% to 3%, of particles of diameter below 75 μm and of hygroscopicity between 0.01 and 5%, preferably between 0.05 and 3% and more preferably between 0.08 and 1%, said pulverulent composition comprising at least one polyol (also known as sugar alcohol).

The pulverulent composition according to the invention makes possible complete or partial replacement of inorganic agents of anticaking or plasticizing types, such as talc, during the step of dusting the strip of chewing gum, while maintaining an efficient method and while retaining the organoleptic qualities of the chewing gum obtained.

Within the meaning of the invention, the step of mixing the ingredients relates to the step of mixing the base gum with the flavorings and any other ingredient in order to obtain the paste to be chewed, which will be extruded and then dusted before being rolled and then cut up or formed.

“Particles below 75 μm” means any particle that can be detected by means of a LASER diffraction particle size analyzer of type LS 230 from the company BECKMAN-COULTER, of a particle size from 75 μm to 0.4 μm.

Thus, the values of particle size distribution are determined on a LASER diffraction particle size analyzer of type LS 230 from the company BECKMAN-COULTER, equipped with its module for powder dispersion by aspiration (aspirator of 1400 watts) of the sample (dry method), following the manufacturer's technical manual and specifications.

The operating conditions of screw speed under hopper and of intensity of vibration of the dispersion chute are determined in such a way that the optical concentration is between 4% and 12%, ideally 8%.

The range of measurement of the LASER diffraction particle size analyzer of type LS 230 is from 0.4 μm to 2000 μm. The results are calculated in vol. %, and expressed in μm. The method of calculation used is that according to the theory of FRAUNHOFER.

The measurement gives access to the proportion of fines notably below 75 μm. The curve of particle size distribution also makes it possible to determine the value of the volumetric mean diameter (arithmetic mean) D4.3.

The test for measurement of the hygroscopicity consists here of evaluating the weight change of the sample measured when it is submitted to different relative humidities (RH) at 20° C. in equipment manufactured by the company SURFACE MEASUREMENTS SYSTEMS (London UK) and designated Dynamic Vapor Sorption Series 1.

This equipment consists of a microbalance which makes it possible to quantify the weight variation of a sample relative to a reference (here the reference boat of the differential balance is empty) when the latter is submitted to different climatic conditions.

The carrier gas is nitrogen, and the weight of the sample is between 10 and 11 mg. The programmed RH are 20, 40, 60 and 80%. The stability factor that allows automatic passage from one RH to the next is the ratio dm/dt, which is fixed at 0.002% for 20 minutes.

Finally, the hygroscopicity expressed is the result of the following calculation: [(m80−m20)/m20]×100, where m20 is the weight of the sample at the end of the time of holding at 20% RH, and m80 the weight of the sample at the end of the time of holding at 80% RH.

So that dusting can be carried out in conditions of temperature and of relative humidity that are common in the production workshops, it is preferable to use a slightly hygroscopic powder.

According to one variant, the dusting powder is a pulverulent composition comprising 50 to 100% of a polyol, preferably 75 to 99%, more preferably 85 to 98.5%, even more preferably 90 to 98%, very preferably 92 to 97% of a polyol.

Preferably, the pulverulent composition has an average diameter (arithmetic mean) D4.3 between 75 μm and 400 μm, preferably between 100 μm and 350 μm and more preferably between 110 μm and 250 μm, even more preferably between 125 and 240 μm, typically between 150 and 225 μm.

Advantageously, the pulverulent composition according to the invention has a flow grade between 55 and 90, preferably between 60 and 85, and more preferably between 65 and 80.

The flowability is evaluated using the POWDER TESTER instrument of type PTE marketed by the company HOSOKAWA. This instrument makes it possible to measure, in standardized and reproducible conditions, the flowability of a powder and calculate a flow grade, also called flowability index, based on the work of Mr Ralph Carr (1965). The flow grade is calculated from the values obtained using the following four tests: compressibility, angle of repose, spatula angle, uniformity (see technical manual of the POWDER TESTER instrument of type PTE). For this last test, the particle size used is that obtained by laser particle size analysis described above.

Good flow of the pulverulent composition permits easy application of the method, without major modification of the conditions of application in comparison with the use of talc.

According to a preferred variant, the pulverulent composition according to the invention is a composition of crystals.

In the sense of the invention, “composition of crystals” means a crystalline composition produced by the crystallization of a solution of polyol (a polyol in a solvent) or of a polyol melt (solid melted in the absence of solvent) i.e. in the form of predominantly individualized crystals. Therefore it is not a question here of a form of granulated crystals. The crystalline composition can be a mixture of crystals of several polyols.

The expression crystalline composition also covers compositions obtained by grinding following the step of crystallization. The crystalline composition can be a mixture of crystals of several polyols.

Typically, said crystals are obtained by single crystallization or fractional crystallization (several successive steps of crystallization) and notably by cooling of a melt, by evaporation or evapo-crystallization of a solution of polyol or by addition of a diluent. Preferably, the solution is aqueous.

According to a first variant, crystallization is single and is carried out by thermal methods such as by cooling of a polyol melt, by evaporation. Partial evaporation permits, by concentration of the solution of polyol, crystallization in the form of predominantly individualized crystals.

The evaporation is called adiabatic when the vaporization of the solvent causes a temperature decrease; this is known as evapo-crystallization.

According to a second variant, crystallization is single and is carried out by physicochemical methods. Typically, crystallization is effected by addition of a diluent, more particularly of an organic solvent such as an alcohol.

According to a third variant, crystallization is carried out in a fractional manner, i.e. by successive crystallizations, the crystals obtained in each step are solubilized or dissolved in a solvent or melted and then crystallized again.

Typically, the step of crystallization is followed by a step of selection of the particles, optionally preceded by grinding of the crystals obtained.

According to another preferred variant, the pulverulent composition is a composition of agglomerates of crystals.

According to the invention, the expression “composition of agglomerates of crystals” means a composition obtained by agglomeration otherwise called granulation of crystals including at least crystals of polyol. A composition suitable for application of the method according to the invention can be obtained by the technique of granulation by a wet method or by a dry method. These technologies are described in the literature (Agglomeration Processes, Phenomena, Technologies, Equipment by Wolfgang Pietsch Chapter 6 “Agglomeration Technologies”, WILEY—VCH, 2002).

In the case of the wet granulation technique, three technologies are conventionally employed: the mixer technology, the fluidization technology and the compression technology. The mixer technology can be carried out with low or high shear. The fluidization technology can be carried out on fluidized air bed granulators or in spray-drying towers. The compression technology is carried out on extruders, graters, screens or perforated plates. These technologies can be operated batchwise or continuously. They are combined with a step of drying, simultaneously or subsequently, a step of cooling and an optional step of classification with recycling of the undesired fractions of products.

In a first preferred embodiment of the method, use may be made, for example, of a vertical continuous mixer-agglomerator of Schugi Flexomix type sold by Hosakawa, in which the starting crystals to be agglomerated are introduced continuously via a weight metering device and the binder is introduced continuously via a volumetric metering device, the binder being in the form of a liquid, a powder or a suspension. In this method, the starting crystals and the binder are intimately mixed in the mixer-agglomerator equipped with a shaft with knives positioned as blades and with a system for spraying liquids via injection nozzles. It will be possible to preferably choose a twin-fluid nozzle in which the binder is converted into the form of fine droplets by a fluid under pressure. The choice will advantageously be made of compressed air or pressurized water steam.

In a preferred form of the method, the satisfactory dispersion of the constituents and the agglomeration of the starting crystals are produced by stirring at high speed, that is to say with a value at least equal to 2000 rpm, preferably at least equal to 3000 rpm. At the outlet of the mixer-agglomerator, the agglomerates formed are continuously discharged by gravity into a dryer.

This second step of drying at the outlet of the mixer-agglomerator makes it possible to remove the solvent originating from the binder and to give solidity to the agglomerates. The dryer can be, for example, a fluidized bed dryer or a rotary drum dryer.

The composition formed of agglomerates of crystals in accordance with the invention is obtained after cooling and optionally sieving. In this case, the fine particles can be directly recycled at the start of granulation and the coarse particles can be ground and recycled at the start of sieving or at the start of granulation.

In a second preferred embodiment of the method, the choice is made to carry out the wet granulation of the crystals in a spray-drying tower. The crystals and the binder are then introduced continuously into said spray-drying tower in the form of fine droplets via a spray nozzle. In this method, it is ensured that the starting crystals and the binder are brought intimately into contact. For this, the crystals are injected into the atomization spray of the binder.

In a preferred form of the method, the choice is made to use an MSD (Multi-Stage Dryer) spray-drying tower sold by Niro having a water evaporation capacity of the order of 350 kg/h. The starting crystals are then fed continuously at a flow rate of between 400 and 600 kg/h approximately, the wet granulation being carried out with a solvent, such as water, as binding agent, as will be exemplified below. Satisfactory spraying of the binder is provided by a high-pressure spray nozzle. The agglomerates of crystals obtained are subsequently cooled on a vibrated fluidized bed. In view of the melting points of the crystals, the Applicant Company found that it was necessary to very closely monitor the operating temperatures of the spray-drying tower.

According to another variant, the pulverulent composition is a composition of granules.

“Composition of granules” or “granular composition” means a composition having a spherical structure in scanning microscopy obtained by atomization of a solution or of a suspension containing at least one polyol. Atomization can be carried out notably with a multiple-effect atomizer, such as marketed by GEA-NIRO.

According to a second variant, the pulverulent composition is a composition of co-agglomerates.

“Co-agglomerates” means a powder obtained by atomization of a solution or of a suspension containing at least one polyol followed by granulation of the powder obtained.

Such a composition can be obtained for example by atomization of a solution or suspension containing at least one polyol in a spray-drying tower of the MSD type equipped with a high-pressure atomizing nozzle, with recycling of the fine particles to the top of the tower, so as to obtain a co-agglomerate. Such a composition in fact contains no, or very few, fine particles.

Advantageously, the method according to the invention employs a pulverulent composition composed of a mixture of any one of the co-agglomerates, granules, crystals or agglomerates of crystals. Thus, the characteristics and the proportions of this composition can be finely controlled, without adding talc, while preserving good efficiency of application of the method and endowing the chewing gum obtained with good organoleptic characteristics.

According to a variant of the invention, the pulverulent composition is obtained by employing technology for separation of its constituent particles or crystals as a function of their size and their weight; in particular a method making it possible to extract the fraction of grains or of crystals having the largest size.

This de-fining or separation of particles can be applied by techniques of sieving or with pneumatic separators.

“Pneumatic separators” means equipment that separates powders according to their particle size by the use of a stream of air. Such separators are described in the article “Classification pneumatique” [“Pneumatic classification”] by Pierre BLAZY and El-Aid JDID in Technique de l′ingénieur, traité Génie des Procédés [Engineering Techniques, Process Engineering treatise]. These separators can have static selection chambers using a horizontal or vertical or mixed gas stream; such separators can be with or without baffles. Another type of pneumatic separator is the separator using centrifugal force. Among the latter, static cyclones, separators with a horizontal-axis rotor and vertical-axis mechanical separators are described.

Preferably, the crystalline powders are obtained by crystallization then selection of particles, preferably the selection of particles is carried out by sieving or on a pneumatic separator. Advantageously the pneumatic separator is a static separator preferably with vertical gas stream. Particularly advantageously, the pneumatic separator is a zigzag separator.

According to a variant of the invention the polyol is a hydrogenated monosaccharide, or a hydrogenated disaccharide or mixture thereof; preferably selected from mannitol, isomalt, xylitol, maltitol, erythritol, lactitol; sorbitol or mixtures thereof. Preferably, the polyol is selected from erythritol, mannitol, isomalt and mixtures thereof.

Preferably, the pulverulent composition also comprises a protein or a polysaccharide notably selected from starches, maltodextrins, dextrins, gums, pectin and cellulosic derivatives or a mixture thereof.

Typically, the proteins are chosen from fibrous proteins, such as collagen or the product of its partial hydrolysis. The example of a product from the hydrolysis of collagen is gelatin.

“Polysaccharides” is understood to mean polymers formed from a certain number of monosaccharides. Among these polysaccharides, a distinction is made between homopolysaccharides, composed of the same monosaccharide, and heteropolysaccharides, formed of different monosaccharides.

Advantageously, said polysaccharide exhibits:
between 15 and 50% of 1-6 glucoside bonds, preferably between 22 and 45% and more preferably between 27 and 34%,
a content of reducing sugars of less than 20%, preferably of between 2 and 20%, more preferably between 3 and 16% and more preferably still between 3 and 12%,
a polydispersity index of less than 5, preferably of between 0.5 and 4 and more preferably between 1 and 3.5, and
a number-average molecular weight Mn of less than 4500 g/mol, preferably of between 500 and 4500 g/mol, more preferably of between 600 and 4000 g/mol and more preferably still of between 1000 and 2700 g/mol.

A pulverulent composition according to the invention comprises polysaccharides or proteins incorporated in the liquid or powder form as granulation binder during the granulation of polyol crystals or mixed in a suspension or solution of polyol before atomization.

Preferably, the polysaccharide is chosen from starches, maltodextrins or dextrins or their mixtures.

Maltodextrins are conventionally obtained by acid and/or enzymatic hydrolysis of starch. They include a complex mixture of linear or branched saccharides. From the regulatory viewpoint, maltodextrins have a dextrose equivalent (DE) of from 1 to 20.

Mention may be made, among the preferred starches and maltodextrins, of starches or maltodextrins of cereals, such as rice, corn, wheat or sorghum, of tuberous plants, such as potato, cassaya or sweet potato, or of leguminous plants. The term leguminous plants is understood to mean any plant belonging to the families of the Caesalpiniaceae, Mimosaceae or Papilionaceae and in particular any plant belonging to the family of Papilionaceae, such as, for example, pea, bean, broad bean, horse bean, lentil, alfalfa, clover or lupin.

Advantageously, the dusting powder comprises less than 50%, preferably less than 45%, indeed even less than 35%, typically from 10 to 0.1%, of a silicate or carbonate. According to a preferred alternative form, the dusting powder is devoid of silicates or of carbonates preferably of talc.

Within the meaning of the present invention, the silicate is chosen from natural hydrated magnesium silicate or its equivalent synthetic versions, such as magnesium silicate, magnesium trisilicate, indeed even calcium silicate. Among the known carbonates, calcium carbonate is preferred.

The invention also relates to the chewing gum obtained by the implementation of the method according to the invention characterized in that it comprises, at the surface of the chewing gum, a dusting powder comprising a pulverulent composition containing from 28% to 0.1%, preferably from 25% to 1% of particles of diameter below 75 μm and of hygroscopicity between 0.01 and 5%, said pulverulent composition comprising at least one polyol.

The chewing gum according to the invention is paste to be chewed (base gum, flavorings, and the like).

When the chewing gum is in the stick or lozenge form, this surface powder is necessary in order to prevent the sticks from adhering to one another or to prevent the sticks from adhering to the paper. Likewise, when the chewing gum is coated with sugar, a fine layer remains present at the surface of the base gum (or paste to be chewed), despite the removal of dust prior to the coating with sugar. This layer is visible in scanning optical microscopy.

Other characteristics and advantages of the present invention will become clearly apparent on reading the examples given below which will illustrate the invention.

### EXAMPLE 1

| | |
|---|---|
| Mannitol crystals D4.3 = 67 μm | A |
| Mannitol crystals D4.3 = 135 μm | B |
| Mannitol crystals D4.3 = 178 μm | C |
| Mannitol crystals D4.3 = 228 μm | D |
| Mannitol atomized granule D4.3 = 115 | E |
| Mannitol atomized/granule D4.3 = 150 | F |
| Mannitol granulated on Schugi | G |
| Mannitol/starch co-atomized granulated | H |

A syrup of mannitol containing 96% of mannitol was crystallized according to European patent EP0202168.

The first crystallization was carried out to obtain a product of particle size close to 60 μm (sample A), the second to obtain a product of particle size close to 120 μm (sample B). Composition B underwent a step of separation of particles, by means of a zigzag separator.

Sample B is placed in the feed hopper of a zigzag separator, the channel of which has angles of 120°, a width of 20 mm and a depth of 220 mm. It has thirteen stages, each with a height of 92 mm. Feed is effected at the 9th stage. Various separations are carried out in order to obtain defined powders of crystallized mannitol.

For this, in particular the feed rate of primary air is adjusted.

The velocity of the ascending air in fact defines the cutoff diameter of the initial mixture.

Thus, starting from the same powder of mannitol crystals, in the present case sample B, application of a primary air flow rate makes it possible to vary the particle size distribution of the defined mannitol powders.

The conditions of application are presented in Table 1 below.

TABLE 1

| | | | Flow rate | | | | | | | |
|---|---|---|---|---|---|---|---|---|---|---|
| Mannitol | | Flow | Fractions (kg/h) | | Feed | | | Coarse fraction (μm) | | |
| powder | Flow | rate | Flow | Flow | Arithme- | | | Arithme- | | |
| according | rate of | Primary | rate of | rate of | tic mean | | | tic mean | | |
| to the in- | powder | air | fines | coarse | diameter | vol. | vol. | diameter | vol. | vol. |
| vention | (kg/h) | (m³/h) | fraction | fraction | (μm) D(4.3) | % > 75 | % > 250 | (μm) D(4.3) | % > 75 | % > 250 |
| Product | 12 | 27 | 4.2 | 7.8 | 134 | 66.5 | 10.5 | 178 | 85.7 | 18.4 |
| “C” | | | | | | | | | | |
| Product | 12 | 36 | 9.6 | 2.4 | 134 | 66.5 | 10.5 | 228 | 95.1 | 32.5 |
| “D” | | | | | | | | | | |

Two samples are obtained, the first sample, sample C, comprises a proportion of particles below 75 μm of 14.3% and the second sample, sample D, containing 4.9% of particles of particle size below 75 μm.

Samples E and F are obtained by atomization/granulation according to European patent EP 0 645 096 B1 filed by the applicant. These products are marketed by the applicant under the brand name PEARLITOL 100SD (sample E) and PEARLITOL 200SD (sample F).

Sample G is obtained by granulation using a continuous mixer-granulator of the type FLEXOMIX vertical HOSOKAWA SCHUGI according to European patent EP1138661 filed by the applicant.

Sample H is a granulated co-atomized mixture of starch and mannitol, obtained in a tower of the MSD type with recycling of fine particles according to international patent application PCT/FR2009/051293.

TABLE 2

| Samples | A | B | C | D | E | F | G | H |
|---|---|---|---|---|---|---|---|---|
| Proportion of | 65.9 | 33.5 | 14.3 | 4.9 | 15.7 | 9.6 | 3.8 | 5.8 |
| particles below | | | | | | | | |
| 75 μm (%) | | | | | | | | |
| Average diameter | 67 | 135 | 178 | 228 | 115 | 150 | 343 | 182 |
| (μm) | | | | | | | | |
| Flow grade | 41.5 | 51.5 | 62 | 64.5 | 72.5 | 73 | 77 | 72 |
| (out of 100) | | | | | | | | |
| Aerated density | 0.450 | 0.535 | 0.595 | 0.615 | 0.465 | 0.465 | 0.59 | 0.525 |
| (g/ml) | | | | | | | | |
| Packed density | 0.795 | 0.82 | 0.795 | 0.765 | 0.58 | 0.565 | 0.66 | 0.635 |
| (g/ml) | | | | | | | | |

Samples A and B (Table 2), which have a high content of particles below 75 μm, respectively 65.9 and 33.5%, have a low flow grade which predicts difficulties in handling the powder, notably in filling and emptying the containers of these powders.

Samples C to H (Table 2), which have less than 28% of particles below 75 μm, have a high flow grade and therefore easier handling, regardless of their average diameter. It must be emphasized that sample E, of average diameter 115 μm, has a flow grade of 72.5, much greater than that of 51.5 of sample B, which however has a higher average diameter (135 μm).

Regardless of how they are produced, by crystallization, granulation and atomization/granulation, and whether they are pure or compounds, the products according to the invention display improved flow once the proportion of particles below 75 μm is below 28%.

### EXAMPLE 2

Industrial production of chewing gum is carried out on a production line of the TOGUM brand (BOSCH-TOGUM).

This production is carried out with a standard formula of “sugar-free” chewing gum:

Gum base: 32%

Sorbitol powder (NEOSORB® P60W): 49%

Mannitol 60: 7%

Maltitol syrup (LYCASIN® 80/55HDS): 9%

Glycerin: 0.2%

Aspartame: 0.2%

Mint flavor, liquid: 2.1%

Mint flavor, powder: 0.5%

The mixing step is carried out in a Z-arm kneader TOGUM GT120 with a capacity of about 60 kg. Mixing is continuous.

At t=0, the gum base, previously heated overnight at 50° C., and half of the sorbitol powder are placed in the kneader. At t=3 min, the mannitol is introduced, at t=5 min the maltitol syrup, at t=7 min, half of the sorbitol and the aspartame, at t=11 min, the glycerin, at t=12 min, the flavorings. At t=16 min, mixing is stopped and the paste is discharged. The temperature of the paste is then about 55° C. The latter is divided into blocks of about 2 kg which are stored for 1 hour at 20° C., 50% relative humidity, which will give a temperature of the paste of 47° C. before extrusion.

The extrusion step is carried out on TOGUM T0-E82 equipment, with the extruder body heated to 40° C. and the head to 45° C.

The dusting step and the rolling step are carried out on a TOGUM TO-W191 rolling machine. It is equipped firstly with two dusting stations, one positioned above the extruded strip of chewing gum and one above a conveyor belt situated below the strip of chewing gum, the role of which is to supply the dusting powder on the underside of the chewing gum. Thus, the strip of chewing gum is dusted on both faces before the first rolling station. It is then equipped with 4 pairs of rolling rollers, with, located between the second and third pairs, a dedusting system consisting of a pair of brushes, one positioned underneath and the other above the strip of chewing gum. This system is for removing the excess powder from the two faces of the strip of chewing gum. It is finally equipped with two pairs of rollers for forming and cutting, for giving the chewing gum the required final form, in the present case, cushions.

The mannitol powders of reference A to H in example 1 were tested in dusting. The dusting powder was constituted solely of these mannitol powders: no talc was added.

The observations carried out (Table 3) were: ease of obtaining flow of the powder from the dusting equipment, control of the amount of powder deposited relative to the amount desired, amount of powder lost, formation of dusts in suspension in air, and the appearance of the chewing gum after dedusting.

The characteristic “ease of obtaining flow of the powder from the dusting equipment” is observed relative to the homogeneity of deposition of powder on the strip of chewing gum.

The characteristic “control of the amount of powder deposited relative to the amount desired” corresponds to the variations in flow rate of deposition of dusting powder during the process of manufacture of chewing gum.

The “amount of powder lost” corresponds to the ratio of the amount of powder deposited on the strip of chewing gum to that recovered after dedusting of the strip of chewing gum.

The formation of dusts in suspension in air corresponds to visual comparison of the density of powder passed into the air during application of the method.

The appearance of the chewing gum after dedusting corresponds to visual observation of non-uniformity of the layer of powder after dusting and dedusting.

All of these characteristics were classified on a scale of intensity.

Moreover, the chewing gums were tested by a panel of 15 tasters to determine whether the increase in particle size of the dusting powder gives the chewing gum a sandy texture. The tests are carried out according to standard AFNOR V 09-014 (April 1982) on samples A to Z in a group of 5 or 6 samples per test. The 5 or 6 samples were presented simultaneously, imposing a different order of tasting for each member of the panel. The descriptor imposed, namely sandy character in the mouth, is evaluated on a 9-point scale graduated as follows: absence, very slight, slight, definite, pronounced, very pronounced. Analysis of variance (Friedman's ANOVA) discriminates the samples based on their sandy characters (p<<0.05). The values obtained are shown in Table 3.

Samples A and B (Table 3) which have a high proportion of particles below 75 μm display poor flow, making it difficult to control the dusting equipment, and therefore the amount deposited is difficult to control. Accordingly, there is a high level of loss. Moreover, because of the presence of fines, the level of particles in suspension in the air is high.

Samples C to H, with less than 28% of particles below 75 μm, display flow that makes it possible to control the amount of powder deposited and limit the losses. Moreover, the small amount of particles in suspension is an advantage for the cleanness of the premises and the health of the operators. Moreover, the increase in average diameter of the powders does not have negative effects on the organoleptic qualities of the chewing gum obtained: tasting in the mouth revealed no, a very slight or a slight sandy sensation in the mouth.

TABLE 3

| Samples | A | B | C | D | E | F | G | H |
|---|---|---|---|---|---|---|---|---|
| Flow of the | Poor | Poor | Mod- | Good | Good | Good | Good | Good |
| powder | | | erate | | | | | |
| Control of | Poor | Pass- | Rather | Good | Good | Good | Good | Good |
| the amount | | able | good | | | | | |
| of powder | | | | | | | | |
| dusted | | | | | | | | |
| Amount of | Very | High | Mod- | Low | Low | Low | Low | Low |
| powder lost | high | | erate | | | | | |
| Particles in | Many | Few | Few | Very | Very | Very | Very | Very |
| suspension | | | | few | few | few | few | few |
| in the air | | | | | | | | |
| Appearance of | Com- | Com- | Com- | Com- | Com- | Com- | Com- | Com- |
| the chewing | plies | plies | plies | plies | plies | plies | plies | plies |
| gum after | | | | | | | | |
| dedusting | | | | | | | | |
| Sandy | Absent | Absent | Absent | Absent | Very | Slight | Absent | Absent |
| sensation | | | | | slight | | | |
| on tasting | | | | | | | | |
| in the mouth | | | | | | | | |

### EXAMPLE 3

A lumping test is performed in the laboratory. This test simulates the lumping that occurs in big-bags (bags containing from 500 to 1500 kg of powder) of mannitol or along the storage areas of the chewing gum production line.

An amount of 1300 grams of product is put in a polyethylene sachet with thickness of 100 μm (flat dimensions 32.4 cm by 20.9 cm). This sachet is then closed hermetically after expelling the maximum possible amount of occluded air. It is then put in a perforated cylinder with height of 22 cm and diameter of 13 cm, pierced with holes of 8 mm diameter, arranged in a quincunx with a distance of 12 mm between the centers of the adjacent holes. A metallic disk with diameter just less than the cylinder is placed on the sachet. A weight of 6.6 kg, equivalent to a pressure of 580 kg/m², a pressure identical to that acting on the powder at the bottom of a big-bag, is placed on this disk.

The whole is then put in a climatic chamber controlled so that it undergoes 15 cycles of 6 hours (3 hours at a temperature of 15° C. and a relative humidity of 85%, followed by 3 hours at a temperature of 30° C. and a relative humidity of 85%).

At the end of these cycles, the sachet is carefully removed from the cylinder and cut open. A first observation of the powder is carried out. All of the powder is then put in a drum of 5 useful liters (6 liters of total volume with an opening diameter greater than the diameter of the perforated cylinder), which is rotated for one minute in a MIXOMAT A14 recycling mixer (FUSCHS/Switzerland). All of the powder is then poured onto a sieve with meshes with square openings of about 8 mm by 8 mm. Thus, only lumps of product with diameter greater than about 8 mm are recovered, and their total weight is measured. The proportion of product that formed lumps is calculated by dividing the weight of these lumps by the initial weight of mannitol used (1300 grams).

Samples A and B (see Table 4) have a higher proportion of lumped product, which indicates that the powder situated at the bottom of the big-bags will acquire cohesion very quickly after filling and that these big-bags will become very difficult to empty. This packaging is therefore not recommended for these two samples. They are unsuitable for delivery in big-bags since it is very difficult or even impossible to remove such hard blocks from big-bags.

TABLE 4

| Samples | A | B | C | D | E | F | G | H |
|---|---|---|---|---|---|---|---|---|
| Appearance of | Hard | Friable | Very | Fluid | Fluid | Fluid | Fluid | Fluid |
| the powder | block | block | friable | powder | powder | powder | powder | powder |
| | | | block | | | | | |
| Proportion of | 24% | 18% | 8% | 0% | 8% | 0% | 0% | 0% |
| lumped product | | | | | | | | |

Moreover, the equipment used for conveying and dusting the powder during the production of chewing gum is intended for a powder without very hard agglomerates which risk at any moment blocking and stopping the dusting, which results in almost immediate stoppage of the line, as the strip of chewing gum sticks to all the equipment. To use these samples, grinding and sieving will be essential.

For samples C and E, which have a level of lumping of 8%, this packaging is conceivable but storage will have to have a time limit. For samples D, F, G and H, filling, storage and emptying of the big-bags will not present any difficulty: they can be commercialized in this type of equipment without any problems and can then be used in dusting of the strip of chewing gum without any reprocessing.

### EXAMPLE 4

Samples J to Y obtained according to the methods described below are defined and identified in Table 5.

TABLE 5

| | |
|---|---|
| Maltitol crystals D4.3 = 43 μm | J |
| Maltitol agglomerated Schugi D4.3 = 89 μm | K |
| Maltitol agglomerated on Schugi D4.3 = 161 μm | L |
| Xylitol crystals D4.3 = 129 μm | M |
| Xylitol agglomerated Schugi D4.3 = 343 μm | N |
| Isomalt crystals D4.3 = 51 μm | O |
| Isomalt agglomerated Schugi D4.3 = 153 μm | P |
| Maltitol crystals D4.3 = 61 μm | Q |
| Maltitol agglomerated in MSD tower D4.3 = 230 μm | R |
| Xylitol crystals D4.3 = 72 μm | S |
| Xylitol agglomerated in MSD tower D4.3 = 178 μm | T |
| Xylitol/BDM D4.3 = 290 μm | U |
| Mannitol/starch co-atomized granulated D4.3 = 108 μm | V |
| Maltitol agglomerated D4.3 = 265 μm | W |
| Mannitol compacted D4.3 = 223 μm | X |
| Mixture 50% mannitol crystals (A example 1) and 50% | Y |
| maltitol crystals (Q) | |

Samples J and Q are crystalline maltitol obtained by the use of a crystallization process as described in European patent EP 0 905 138. The powder obtained is subsequently ground in order to obtain a product with a particle size of approximately 40 μm (sample J) and 60 μm (sample Q).

Samples K and L are obtained by the use of the granulation process from sample J with the Schugi agglomerator according to the steps described above and under the flow rate, pressure and temperature conditions defined in table 6. Sample K is granulated with water and sample L is granulated with a maltitol syrup having a solids content of 50% with the Schugi agglomerator according to the steps described above and under the conditions defined in table 6.

Samples M and S are obtained by crystallization from water of a xylitol syrup. Cristallization was carried out in order to obtain a product with a particle size of approximately 130 μm (sample M). Sample M is subsequently ground in order to obtain a powder with a particle size of 72 μm (sample S).

Sample N is obtained by granulation of sample J by the use of a vertical continuous mixer/agglomerator of Flexomix type from Hosokawa Schugi according to the steps described above and under the flow rate, pressure and temperature conditions defined in table 6.

Sample O is obtained by crystallization according to the conditions described in patent EP 1 674 475; the crystalline powder obtained is subsequently ground so as to obtain a powder having a mean particle size of 51 μm.

Sample P is obtained by the use of the granulation process with the Schugi agglomerator from sample 0 according to the conditions described in table 6.

Sample Y is obtained by the use of the granulation process with the Schugi agglomerator from samples A of Example 1 and Q in a 1/1 ratio according to the conditions described in table 6.

TABLE 6

| | K | L | N | P | Y |
|---|---|---|---|---|---|
| Starting | J | J | M | O | 50% A |
| crystals | | | | | 50% Q |
| Flow rate of | 500 | 500 | 500 | 500 | 500 |
| powder | | | | | |
| (kg/h) | | | | | |
| Flow rate of | 25 | 25 | 40 | 65 | 80 |
| binder (l/h) | | | | | |
| Binder | Water | Maltitol | Water | Water | Water |
| | 80° C. | 50% DM | 80° C. | 80° C. | 80° C. |
| | | 80° C. | | | |
| Bi-fluid | Air | Air | Air | Air | Air |
| nozzle | | | | | |
| Pressure | 2 | 2 | 2 | 2 | 2 |
| (bar) | | | | | |
| Temperature | 70 | 100 | 80 | 90 | 120 |
| of drying | | | | | |
| air (° C.) | | | | | |
| Sieve | <800 μm | <800 μm | <800 μm | <800 μm | <800 μm |

Sample R was obtained by granulating sample Q in an MSD spray-drying tower.

The MSD spray-drying tower used comprises an evaporation capacity of 350 kg/h and is fed via a powder weight metering device with crystalline maltitol Q (sample Q) at a flow rate of 500 kg/h. Granulation is carried out by spraying water at a flow rate of 110 l/h via a nozzle at a pressure of 50 bar. The main drying air enters the tower at 180° C. and the drying air of the static bed enters the tower at 70° C. The temperature of the outlet vapors is then 90° C. (table 7). On departing from the spray-drying tower, the product passes over a vibrated fluid bed, where it is cooled by air in 3 temperature regions respectively set at 35° C., 20° C. and 20° C.

Sample T was obtained by granulating sample S in an MSD spray-drying tower according to the steps described above and the conditions described in table 7.

TABLE 7

| | R | T |
|---|---|---|
| Starting crystals | Q | S |
| Flow rate of powder | 500 | 500 |
| (kg/h) | | |
| Flow rate of binder | 110 | 70 |
| (l/h) | | |
| Binder | Water 80° C. | Water 80° C. |
| Nozzle pressure | 50 | 40 |
| (bar) | | |
| Temp drying air (° C.) | 180 | 135 |
| Temp air static bed | 70 | 75 |
| (° C.) | | |
| Temp damp vapor | 90 | 75 |
| outlet | | |

Sample U is obtained by granulation with an aqueous solution comprising 30% as dry matter (DM) of branched maltodextrins (BMD) (sold by the Applicant Company under the name Nutriose® FM06). 500 g of a 77 μm xylitol powder are deposited in the container of the dryer/agglomerator having a fluidized air bed of Strea-1 type from Aeromatic equipped with an injection nozzle.

The xylitol powder is suspended at a temperature of 60° C. by air pulsed at the base of said container. The solution of branched maltodextrins is subsequently sprayed at a flow rate of 4 ml/min and at a pressure of 1 bar. The granules, recovered after a residence time of from 25 to 30 min, are recovered and dried in said agglomerator at 60° C. for 30 minutes. The granules are subsequently graded on a graded sieve with a mesh size of between 100-500 μm. The pulverulent composition obtained is composed of 95% xylitol and 5% branched maltodextrins.

Sample W is a maltitol powder obtained by wet granulation of a crystalline maltitol with a maltitol syrup according to the following conditions:

25 kg of sample Q are introduced into a Glatt AGT 400 granulator operating in batch mode (the outlet of the air classifier is closed). The inlet air flow rate is regulated at 800 m³/h with a temperature of 100° C. (so as to obtain a speed of the fluidizing air at a value of between 1 and 2 m/s). A syrup with a solids content of 27% and where the maltitol richness is 75%, composed of 1.7 kg of maltitol of Maltisorb® 75/75 type (sold by the Applicant Company) diluted with 3 kg of water, is sprayed at a temperature of 40° C. using a twin-fluid nozzle (air pressure of 4 bar) in the bottom spray position over the maltitol particles moving in the air stream. The flow rate of the spraying is regulated so as to obtain a temperature in the bed of moving particles of 31° C. (air flow rate 800 m³/h, air temperature during the spraying 100° C.). At the end of the spraying, the temperature of the air is increased up to 120° C. These conditions are maintained until the temperature in the powder bed has risen to 75° C.

The powder is subsequently cooled to 20° C. and then sieved between 100 and 500 μm.

Sample X is obtained by dry granulation of sample A from Example 1. Sample A from Example 1 was compacted on an Alexanderwerk WP120 roller compacter. The compacting pressure is regulated at 40 bar. The two successive granulators are successively equipped with screens of 1600 μm and then of 600 μm.

Samples J, O and Q (Table 8) have a high content of particles smaller than 75 μm, respectively of 84.4%, 78.2% and 71.1%. They have, moreover, poor flow reflected in a low flow grade of 47; 49; and 47 respectively. Other samples, although having a smaller amount of particles having a particle size below 75 μm, have a low flow grade, such is the case with samples M, and S which have respectively a percentage of particles below 75 μm of 30.3%, and 58.7% for a flow grade of 41 and 34.

In contrast, it must be noted that samples K, L, N, P, R, T to X and Y have both a good flow namely greater than 55 and a good particle size profile with a percentage of powder having a particle size below 75 μm of less than 60%. Thus, powders of mannitol, of maltitol, of xylitol or of isomalt or of Xylitol/BDM, Mannitol/starch mixture having a very good flow grade and a small amount of particles of fine particle size could be obtained.

To achieve a flow grade above 60, it is preferable to use a powder whose content of particles smaller than 75 μm is below 50%.

TABLE 8

| Samples | I | J | K | L | M | N | O | P | Q | R | S | T | U | W | X | Y |
|---|---|---|---|---|---|---|---|---|---|---|---|---|---|---|---|---|
| Propor- | 13.0 | 84.4 | 35.2 | 8.8 | 30.3 | 2.4 | 78.2 | 10.7 | 71.1 | 12.5 | 58.7 | 15.6 | 2.2 | 4.5 | 17.6 | 10.9 |
| tion of | | | | | | | | | | | | | | | | |
| particles | | | | | | | | | | | | | | | | |
| below | | | | | | | | | | | | | | | | |
| 75 μm | | | | | | | | | | | | | | | | |
| (%) | | | | | | | | | | | | | | | | |
| Average | 198 | 43 | 89 | 161 | 129 | 341 | 51 | 153 | 61 | 230 | 72 | 178 | 290 | 265 | 223 | 184 |
| diame- | | | | | | | | | | | | | | | | |
| ter (μm) | | | | | | | | | | | | | | | | |
| Flow | 72 | 47 | 63 | 76 | 41 | 68 | 49 | 74 | 47 | 65 | 34 | 68 | 80 | 85.5 | 61 | 74 |
| grade | | | | | | | | | | | | | | | | |
| (out of | | | | | | | | | | | | | | | | |
| 100) | | | | | | | | | | | | | | | | |
| Aerated | 0.64 | 0.38 | 0.56 | 0.51 | 0.45 | 0.57 | 0.42 | 0.54 | 0.50 | 0.56 | 0.45 | 0.54 | 0.71 | 0.68 | 0.62 | 0.55 |
| density | | | | | | | | | | | | | | | | |
| (g/ml) | | | | | | | | | | | | | | | | |
| Packed | 0.78 | 0.83 | 0.72 | 0.59 | 0.86 | 0.66 | 0.78 | 0.66 | 0.89 | 0.69 | 0.89 | 0.63 | 0.78 | 0.71 | 0.77 | 0.69 |
| density | | | | | | | | | | | | | | | | |
| (g/ml) | | | | | | | | | | | | | | | | |
| Hygro- | 0.09 | 0.11 | 0.13 | 0.35 | 0.09 | 1.2 | 1.5 | 1.61 | 0.11 | 0.14 | 0.13 | 1.4 | 4.0 | 0.37 | 0.09 | 0.10 |
| scop- | | | | | | | | | | | | | | | | |
| icity | | | | | | | | | | | | | | | | |

### EXAMPLE 5

Chewing gums are obtained by application of the method according to example 2 from identical compositions.

The powders with reference J to Y of example 4 were tested in dusting in the same way and according to the same protocols as example 2 (Table 9).

TABLE 9

| | Powder | Control of | | | Appearance of | Sandy sen- |
|---|---|---|---|---|---|---|
| | flow of | the amount | Amount of | Particles | the chewing | sation on |
| Sam- | the dusting | of powder | powder | suspended | gum after | tasting in |
| ples | equipment | dusted | lost | in the air | dedusting | the mouth |
| J | −− | −− | −− | −− | C | ++ |
| K | ++ | ++ | ++ | +/− | C | +/− |
| L | ++ | ++ | ++ | ++ | C | +/− |
| M | −− | −− | −− | ++ | C | + |
| N | ++ | ++ | ++ | ++ | +/− | + |
| O | +/− | −− | −− | −− | C | +/− |
| P | ++ | ++ | ++ | ++ | C | + |
| Q | −− | −− | −− | −− | C | ++ |
| R | ++ | ++ | ++ | ++ | C | ++ |
| S | −− | −− | −− | −− | C | ++ |
| T | ++ | ++ | ++ | ++ | C | + |
| U | ++ | ++ | ++ | ++ | +/− | +/− |
| V | ++ | ++ | ++ | ++ | C | ++ |
| W | ++ | ++ | ++ | ++ | +/− | +/− |
| X | + | ++ | + | ++ | C | +/− |
| Y | ++ | ++ | ++ | − | C | + |
| Y | ++ | ++ | ++ | ++ | C | +/− |

In Table 9, the symbols correspond to the following meanings.

For flow of the powder and control of the amount of powder dusted: “++”=very good, “+”=good, “+/−”=passable, “−”=poor and “−−”=very poor.

For the amount of powder lost and the amount of particles in suspension “−−”=very high, “−”=high, “+/−”=low and “+”=very low. For the characteristic of sandy sensation in the mouth during tasting: “++”=absence, “+”=very low, “+/−”=low.

For the appearance of the chewing gum after the removal of dust, “C”=appearance conforms (upper and lower surfaces uniformly dusted), “+/−”=the amount remaining after removal of dust forms a nonuniform layer; regions which have been dusted to an excessively slight extent remain, forming sticking regions along the strip of chewing gum. Samples N, U and W, which exhibit a very high mean diameter of 341, 290 and 265 μm respectively and a very low content of particles of less than 75 μm of 2.4, 2.2 and 4.5% respectively, give the strip of chewing gum, after removal of dust, a nonuniform layer of powder insufficient to provide effective dusting.

Sample K, which exhibits a mean diameter of 89 μm, generated slightly more particles in suspension in the air than the other granulated products.

Samples J, M, O, Q and S (table 9), which exhibit a high content of particles of less than 75 μm, exhibit poor flow, which makes it difficult to regulate the dusting equipment and thus to control the amount deposited. Consequently, the level of loss is high. Furthermore, because of the presence of fines, the content of particles in suspension in the air is high.

Samples K, L, N, P, R and T to Y, exhibiting less than 50% of particles of less than 75 μm and a flow grade of greater than 60, have a flow which makes it possible to control the amount of powder deposited and to limit the losses. Furthermore, the low amount of particles in suspension is an advantage for the cleanliness of the sites and the health of the operators. Furthermore, the increase in the mean diameter of the powders does not have negative consequences with regard to the organoleptic qualities of the chewing gum obtained: the tasting in the mouth did not reveal any gritty sensation in the mouth, the particle size being compensated for by the high solubility of the agglomerates of polyols.

### EXAMPLE 6

A lumping test is carried out in the laboratory in the same conditions as example 3.

TABLE 10

| Samples | J | K | L | M | N | Q | R | S | T | U | V |
|---|---|---|---|---|---|---|---|---|---|---|---|
| Appearance of | −− | − | +/− | −− | + | −− | + | −− | +/− | + | + |
| the powder | | | | | | | | | | | |
| Proportion of | 47 | 29% | 22% | 75% | 0% | 38% | 0% | 85% | 17% | 0% | 0% |
| lumped product | | | | | | | | | | | |

Regarding the characteristic of appearance of the powder (Table 10): “+”=fluid powder, “+/−”=presence of friable blocks, “−”=presence of hard blocks, “−−” presence of very hard blocks.

Samples J, M, Q and S (see Table 10) have a very high proportion of lumped product (from 29 to 85%) and very hard blocks. They are unsuitable for delivery in big-bags since it is very difficult or even impossible to remove such hard blocks from big-bags.

Moreover, the equipment for conveying and dusting the powder during production of chewing gum is intended for a powder without very hard agglomerates which risk at any moment blocking and stopping the dusting, which results in almost immediate stoppage of the line, as the strip of chewing gum sticks to all the equipment.

To use these samples, grinding and sieving will be essential.

Sample T which has a level of lumping of 17%, packaging in big-bags is conceivable as the blocks observed are friable and can be broken up by simple sieving. For samples N, R and U, V, with very low proportions of lumped product (<5%) and often zero, the filling, storing and emptying of the big-bags will not present any difficulty: they can be commercialized in this type of equipment without any problem and can then be used in the dusting of the strip of chewing gum without any reprocessing.

1. Method of production of chewing gum comprising a step of mixing the ingredients, a step of extrusion of the mixture, a step of dusting with a dusting powder, a rolling step and a forming-cutting step, wherein said dusting powder comprises a pulverulent composition containing less than 28%, preferably from 28 to 0.1% of particles of diameter below 75 μm and of hygroscopicity between 0.01 and 5%, said pulverulent composition comprising at least one polyol.

2. Method as claimed in claim 1, wherein said pulverulent composition has an average diameter between 100 μm and 400 μm, preferably between 125 μm and 350 μm.

3. Method as claimed in claim 1, wherein the pulverulent composition has a flow grade between 55 and 90, preferably between 60 and 85.

4. Method as claimed in claim 1, wherein the pulverulent composition is a composition of crystals.

5. Method as claimed in claim 1, wherein the pulverulent composition is a composition of agglomerates of crystals.

6. Method as claimed in claim 1, wherein the pulverulent composition is a composition of granules.

7. Method as claimed in claim 1, wherein the pulverulent composition is a composition of co-agglomerates.

8. Method as claimed in claim 1, wherein the pulverulent composition is a mixture of co-agglomerates, of granules, of crystals and/or of agglomerates of crystals.

9. Method as claimed in claim 1, wherein the polyol is selected from mannitol, isomalt, xylitol, maltitol, erythritol, lactitol and mixtures thereof.

10. Method as claimed in claim 1, wherein the pulverulent composition comprises a polysaccharide.

11. Method as claimed in claim 10, wherein the polysaccharide is selected from starches, maltodextrins, dextrins or a mixture thereof.

12. Method as claimed in claim 1, wherein the dusting powder comprises less than 50% of a silicate or of a carbonate.

13. A chewing gum obtained by application of the method as claimed in claim 1, wherein it comprises, on the surface of the mixture, a dusting powder comprising a pulverulent composition containing from 28% to 0.1% of particles of diameter below 75 μm and of hygroscopicity between 0.01 and 5%, said pulverulent composition comprising at least one polyol.

14. Method as claimed in claim 2, wherein the pulverulent composition has a flow grade between 55 and 90, preferably between 60 and 85.

15. Method as claimed in claim 2, wherein the pulverulent composition is a composition of crystals.

16. Method as claimed in claim 3, wherein the pulverulent composition is a composition of crystals.

17. Method as claimed in claim 2, wherein the pulverulent composition is a composition of agglomerates of crystals.

18. Method as claimed in claim 3, wherein the pulverulent composition is a composition of agglomerates of crystals.

19. Method as claimed in claim 2, wherein the pulverulent composition is a composition of granules.

20. Method as claimed in claim 3, wherein the pulverulent composition is a composition of granules.
